(19) United States
(12) Patent Application Publication
(10) Pub. No.: US 2024/0201000 A1
(43) Pub. Date: Jun. 20, 2024

(54) Flood Sensor and Notification System

(71) Applicant: Nippon Telegraph and Telephone Corporation, Tokyo (JP)

(72) Inventors: Hiroaki Taguchi, Musashino-shi, Tokyo (JP); Masaya Nohara, Musashino-shi, Tokyo (JP); Mikayo Iwata, Musashino-shi, Tokyo (JP); Takeshi Komatsu, Musashino-shi, Tokyo (JP)

(21) Appl. No.: 18/555,617

(22) PCT Filed: May 26, 2021
(86) PCT No.: PCT/JP2021/019990

§ 371 Date: Oct. 16, 2023

(51) Int. Cl. G01F 23/22

(52) U.S. Cl. CPC G01F 23/223

(57) ABSTRACT

A flood sensor includes a notification unit that notifies of detection of flooding, and a primary battery. The primary battery includes a positive electrode, a negative electrode, and a separator that is disposed between the positive electrode and the negative electrode and to which an electrolyte adheres. When the separator is flooded, the electrolyte is dissolved in water to form an electrolyte solution, and the primary battery starts generating power to supply power necessary for driving the notification unit.

### TECHNICAL FIELD

The present invention relates to a flood sensor and a notification system.

### BACKGROUND ART

Conventionally, alkaline batteries, manganese batteries, air batteries, and the like are widely used as disposable primary batteries.

In addition, in recent years, with the development of the Internet of Things (IOT), the development of deployed sensors installed and used in any place in nature such as in the soil or in a forest has also progressed. Small and high-performance lithium ion batteries for various applications such as these small sensors have also become widespread.

As one sensor installed outdoors, there is a flood sensor using a specific low power radio (see Non Patent Literature 1). The flood sensor described in Non Patent Literature 1 detects water when the installation position is flooded to a predetermined height or more, and notifies of the water using an IoT wireless unit. Also, a sensor network system for flooding or flood damage has been proposed and is being tested (see Non Patent Literature 2). In the sensor network system, various sensors such as a water level, a point flow velocity, or a flap gate opening degree are used.

In general, there is a battery that operates by injecting an electrolyte solution into a battery cell at the time of use (see Non Patent Literature 3). This battery can be stored for a long period of time in a state where no electrolyte solution is injected.

### CITATION LIST

### Non Patent Literature

Non Patent Literature 1: OPTEX Co., Ltd., “Quickly ascertain the danger of submergence and flooding with simple IoT monitoring,” [online], [Retrieved on Mar. 17, 2021], Internet <URL: https://www.optex.co.jp/solutions/flood_solution. html>
Non Patent Literature 2: the Ministry of Land, Infrastructure, Transport and Tourism, “Sensor Network System for Flooding or Flood Damage,” [online], [Retrieved on Mar. 17, 2021], Internet <URL: https://www.mlit.go.jp/tec/i-construction/pdf/matching_180516_siryou_7. pdf>
Non Patent Literature 3: Aqua Power System Japan, “NOPOPO water battery for disaster,” [online], [Retrieved on Mar. 17, 2021], Internet <URL: http://www.aps-j. jp/pdf/NWPx3.pdf>

### SUMMARY OF INVENTION

### Technical Problem

However, in the sensors described in Non Patent Literature 1 and Non Patent Literature 2, a mechanism for detecting and notifying is always operated, and it is necessary to periodically replace the internal battery. In Non Patent Literature 1, the flood sensor itself has zero standby power, but the IOT wireless unit that notifies of flooding is driven by a built-in battery.

The battery described in Non Patent Literature 3 is used by a person injecting an electrolyte solution. Therefore, the battery described in Non Patent Literature 3 cannot supply power in a situation where a person cannot be involved, such as when the battery is installed and used in nature.

In this way, there is no mode for supplying power for notification in response to detection by the sensor.

The present invention has been made in view of the above circumstances, and an object of the present invention is to provide a technique with which power for notification can be supplied in response to detection by a sensor.

### Solution to Problem

According to one aspect of the present invention, there is provided a flood sensor including: a notification unit that notifies of detection of flooding; and a primary battery, in which the primary battery includes a positive electrode, a negative electrode, and a separator that is disposed between the positive electrode and the negative electrode and to which an electrolyte adheres, and when the separator is flooded, the electrolyte is dissolved in water to form an electrolyte solution, and the primary battery starts generating power to supply power necessary for driving the notification unit.

According to one aspect of the present invention, there is provided a notification system including: the flood sensor; and a notification server that is connected to the flood sensor and refers to a position and a height of the flood sensor, in which the notification unit of the flood sensor notifies of flooding of the flood sensor, and the notification server determines an importance of an alarm according to the position and the height of the flood sensor that has notified of flooding.

### Advantageous Effects of Invention

According to the present invention, it is possible to provide a technique with which power for notification can be supplied in response to detection by a flood sensor.

### BRIEF DESCRIPTION OF DRAWINGS

FIG. 1 is a view schematically illustrating an internal structure of a flood sensor according to an embodiment of the present invention in a side view.

FIG. 2 is a view illustrating a system configuration of a notification system according to the embodiment of the present invention.

FIG. 3 is a flowchart illustrating processing of a notification server according to the embodiment of the present invention.

FIG. 4 is a diagram illustrating changes over time in a battery voltage of a primary battery in the flood sensor according to the embodiment of the present invention.

FIG. 5 is a view schematically illustrating an internal structure of a flood sensor according to a first modification of the present invention in a side view.

FIG. 6 is a view schematically illustrating an internal structure of a flood sensor according to a second modification of the present invention in a side view.

FIG. 7 is a diagram illustrating a hardware configuration of a computer to be used in the notification server.

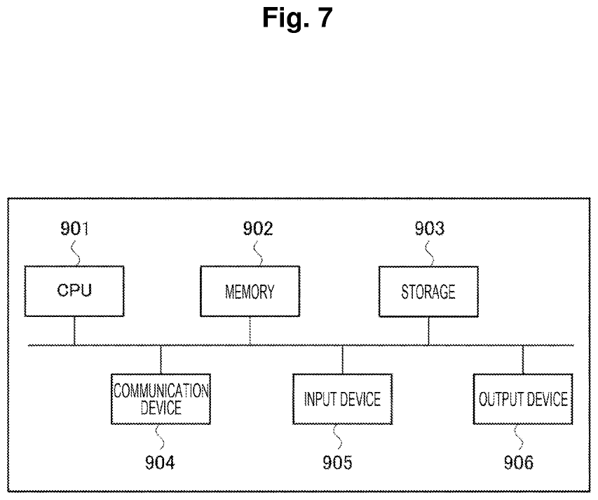

### DESCRIPTION OF EMBODIMENTS

Hereinafter, an embodiment of the present invention will be described with reference to the drawings. In the drawings, the same portions are denoted by the same reference signs, and the description thereof will be omitted.

(Flood Sensor)

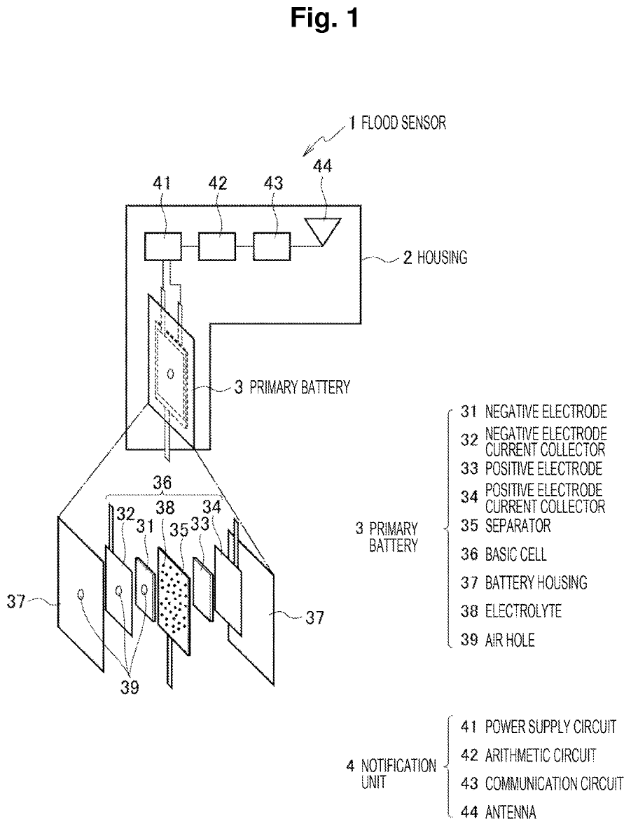

A flood sensor 1 according to an embodiment of the present invention will be described with reference to FIG. 1. The flood sensor 1 includes a housing 2, a primary battery 3, and a notification unit 4. The primary battery 3 includes a positive electrode 33, a negative electrode 31, and a separator 35 that is disposed between the positive electrode 33 and the negative electrode 31 and to which an electrolyte 38 adheres.

In the flood sensor 1 according to the embodiment of the present invention, when the separator 35 in the primary battery 3 is flooded, the electrolyte 38 adhering to the separator 35 is dissolved in water to form an electrolyte solution. The electrolyte 38 diffuses with the water to generate an electrolytic solution, and the separator 35 is immersed in the electrolytic solution.

Accordingly, the primary battery 3 starts generating power and supplies power necessary for driving the notification unit 4. The notification unit 4 notifies of the flood by obtaining electric power. In this way, since the flood sensor 1 is driven using the primary battery 3 that generates power when it is flooded, it is not necessary for it to operate at normal times, and it is possible to notify of the operation only in an emergency. Accordingly, the flood sensor 1 does not self-discharge when not active, and can be operated for a long period of time such as over 10 years.

The primary battery 3 includes a basic cell 36 and a battery housing 37. The basic cell 36 includes a negative electrode 31, a negative electrode current collector 32, a positive electrode 33, a positive electrode current collector 34, and a separator 35. An air hole 39 is formed in the primary battery 3. Air is taken into the primary battery 3 through the air hole 39.

The separator 35 is formed to communicate with the outside in order to take in water during flooding and to make the electrolyte 38 into an electrolytic solution. For example, a part of the separator 35 is exposed from the battery housing 37, communicates with the outside through an opening (not illustrated) of the housing 2, and takes in water during flooding. The opening of the housing 2 is preferably provided below the housing 2, more preferably on the bottom surface, so that the separator is not flooded by rain and snow. In the example illustrated in FIG. 1, the separator 35 includes a main body portion housed in the battery housing 37 and a tape portion exposed from the battery housing 37. The tape portion of the separator 35 is also exposed from the housing 2, and takes in water during flooding.

The arrangement and shape of each member of the negative electrode 31, the negative electrode current collector 32, the positive electrode 33, the positive electrode current collector 34, the separator 35, the battery housing 37, the electrolyte 38, and the air hole 39 are not limited as long as they can operate as a battery. For example, the negative electrode 31, the negative electrode current collector 32, the positive electrode 33, the positive electrode current collector 34, the separator 35, and the battery housing 37 may have a quadrangular or circular sheet shape in a plan view, or may have a shape obtained by rolling a sheet.

The negative electrode 31 is connected to the negative electrode current collector 32. The positive electrode 33 is connected to the positive electrode current collector 34. The separator 35 is disposed between the negative electrode 31 and the positive electrode 33. One surface of the positive electrode 33 is connected to the separator 35.

The negative electrode 31, the negative electrode current collector 32, the positive electrode 33, the positive electrode current collector 34, and the separator 35, which are connected to each other, are sandwiched between the battery housings 37 in the vertical direction, and the peripheral edge portions thereof are bonded and integrated, whereby the inside of the primary battery 3 is sealed. Examples of the bonding method include heat sealing and use of an adhesive, and are not particularly limited. For example, when bonding with heat sealing is difficult, an adhesive is used. When the inside of the primary battery 3 is sealed, the air hole 39 may be formed by opening a part of the peripheral edge portion without bonding or opening a hole. Air can be taken into the primary battery 3 through the air hole 39. The tape portion of the separator 35 is formed to be exposed from a portion which is not bonded and is open at the peripheral edge portion of the primary battery 3.

The positive electrode 33 is of gas diffusion type. Of the surfaces of the positive electrode 33, surfaces other than the surface in contact with the separator 35 are exposed to the atmosphere taken in from the peripheral edge portion of the battery housing 37 or the air hole 39.

The separator 35 is formed of an insulator having water absorbency. Paper such as a coffee filter and a kitchen paper can be used for the separator 35. When a sheet of a material that is naturally decomposed while maintaining strength, such as a cellulose-based separator made of plant fibers, is used as the separator 35, the burden on the environment is reduced even when the flood sensor 1 is not collected after being installed.

The electrolyte 38 may be an electrolyte solution when water is taken in. In order to have a role of water retention, agar, cellulose, a water-absorbing polymer, and the like may be enclosed.

The battery housing 37 may have any configuration as long as the basic cell 36 is maintained inside. In order to prevent the primary battery 3 from generating power due to the separator 35 getting wet with rainwater or the like, a configuration that prevents rain or the like from penetrating into the housing 2 and the battery housing 37 is preferable. The battery housing 37 is preferably formed of, for example, a laminate film.

In addition, by using a material that is naturally decomposed for each of the battery housing 37 and the housing 2, the burden on the environment is reduced even when the flood sensor 1 is not collected. Specifically, each of the battery housing 37 and the housing 2 is formed of any one or more of polylactic acid, polycaprolactone, polyhydroxyalkanoate, polyglycolic acid, modified polyvinyl alcohol, casein, modified starch, and the like. Among these, it is particularly preferable that each of the battery housing 37 and the housing 2 be formed of a chemical synthesis system such as plant-derived polylactic acid. The shape of each of the battery housing 37 and the housing 2 is a shape obtained by processing such biodegradable plastic. The material applicable to each of the battery housing 37 and the housing 2 is, for example, any one or more of biodegradable plastic, a film of biodegradable plastic, a sheet on which a film of a resin such as polyethylene is formed, which is used for a milk pack or the like, an agar film, or the like.

When water comes into contact with the separator 35 due to flooding, water is taken into the separator 35 by capillary action. The electrolyte 38 in the separator 35 is dissolved in water to form an electrolyte solution. When the electrolyte solution thus generated comes into contact with each of the negative electrode 31 and the positive electrode 33, the primary battery 3 starts generating power. The primary battery 3 supplies power to the notification unit 4, so that the notification unit 4 can notify that the flood sensor 1 has detected flooding.

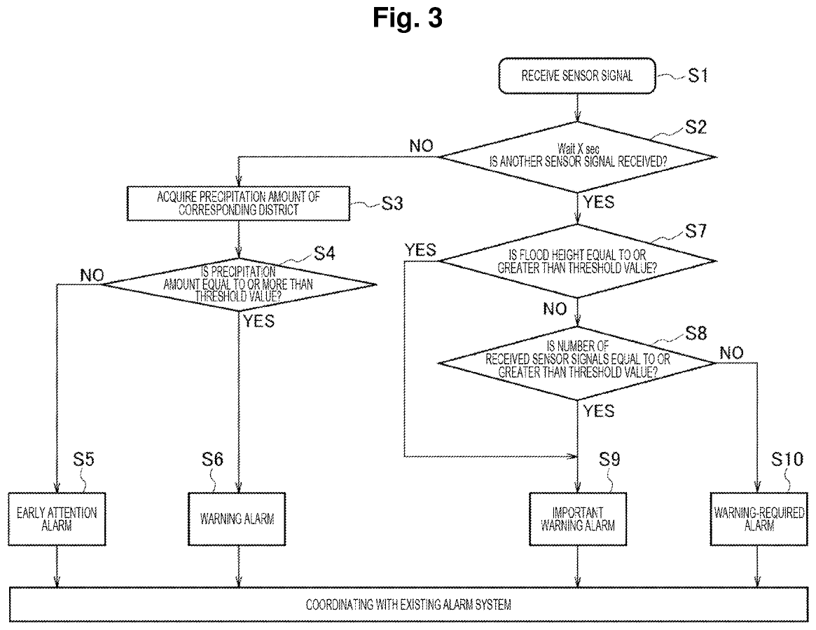

The notification unit 4 notifies of the detection of flooding. In the embodiment of the present invention, as illustrated in FIG. 3, a case where the notification unit 4 notifies the notification server 102 of the detection of flooding via a wireless communication network will be described. The communication wireless network is mobile communication provided by a mobile communication carrier, specific low power radio conforming to a standard such as Association of Radio Industries and Businesses (ARIB) STD-T67, STD-T93, or STD-T108, or the like. As another notification method, a method of turning on a lamp (not illustrated) provided in the flood sensor 1 to give a notification when flooding occurs is considered.

The notification unit 4 includes a power supply circuit 41, an arithmetic circuit 42, a communication circuit 43, and an antenna 44. Each unit of the arithmetic circuit 42, the communication circuit 43, and the antenna 44 is driven by power supplied from the primary battery 3 during flooding.

The power supply circuit 41 converts the power supplied from the primary battery 3 into a voltage that can be used by each circuit. The power supply circuit 41 is, for example, a direct current to direct current (DCDC) circuit. As illustrated in FIG. 1, the negative electrode current collector 32 and the positive electrode current collector 34 are connected to the power supply circuit 41. The power supply circuit 41 converts the power supplied from the negative electrode current collector 32 and the positive electrode current collector 34 into a desired voltage and provides the voltage to each circuit of the notification unit 4.

The arithmetic circuit 42 generates data to be transmitted to the notification server 102 and inputs the transmission data to the communication circuit 43. The transmission data includes an identification number of the flood sensor 1.

The antenna 44 is an interface for connecting to a wireless communication network. The communication circuit 43 communicates with the notification server 102 by using the antenna 44.

In the flood sensor 1 according to the embodiment of the present invention, when flooding occurs, the primary battery 3 built in the flood sensor 1 generates power, and notification by the notification unit 4 becomes possible. The flood sensor 1 does not need to operate at normal times, operates only in an emergency due to occurrence of flooding, and can notify that flooding has occurred. Accordingly, the flood sensor 1 does not self-discharge when not active, and can be operated for a long period of time such as over 10 years.

Further, each member of the flood sensor 1 can be formed of a material that is naturally decomposed. Such a flood sensor 1 is suitably applied to a disposable sensor installed in nature such as a flooding detection sensor or a soil moisture sensor. Since each of the housing 2, the primary battery 3, and the like used in the flood sensor 1 is naturally decomposed over time, it is not necessary to collect the flood sensor 1. In addition, since the flood sensor 1 is composed of a naturally-derived material or a fertilizer component, the burden on the environment is extremely low.

In addition, since the flood sensor 1 according to the embodiment of the present invention has a configuration in which the primary battery 3 can be driven in association with flooding, it is possible to inexpensively and easily install the flood sensor 1 outdoors and replace the flood sensor 1 after flooding. In addition, considering the characteristic that the flood sensor 1 has an extremely low burden on the environment, it is possible to easily ascertain the flooding situation by disposing a large number of flood sensors 1 outdoors.

(Notification System)

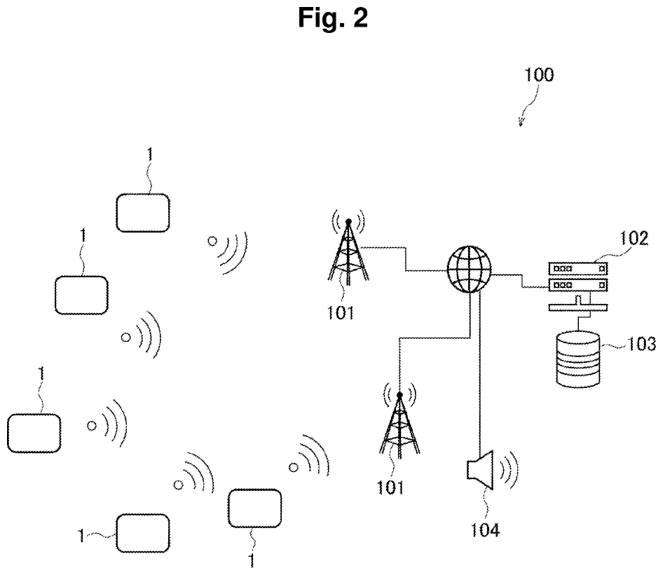

A notification system 100 according to an embodiment of the present invention will be described with reference to FIG. 2. In the notification system 100, a plurality of flood sensors 1 are disposed at various places where flooding is likely to occur due to rainfall or the like.

The notification server 102 monitors and aggregates notifications from the flood sensor 1, specifies a place of occurrence of flooding, a disaster scale, and the like, and provides information to an observer such as a local government or an administrative agency. Note that the system configuration illustrated in FIG. 2 is an example, and is appropriately changed according to the specification of the wireless communication network, the position where the flood sensor 1 is provided, and the like.

The notification system 100 includes a plurality of flood sensors 1, a base station 101, a notification server 102, a database server 103, and a transmission device 104. The flood sensor 1 communicates with the notification server 102 via the base station 101.

The base station 101 is connected to the notification server 102 and is wirelessly connected to the flood sensor 1. The notification server 102 is connected to the plurality of flood sensors 1 via the base station 101. The database server 103 stores the position where the flood sensor 1 is installed, the height such as altitude, and the like, and the notification server 102 can refer to the data stored in the database server 103. The height of the flood sensor 1 is used to estimate the depth of flooding in the flood sensor 1 when it is notified that the flood sensor 1 is flooded. The transmission device 104 transmits an alarm according to the importance of the alarm in the notification server 102. The transmission device 104 is a device used by an observer such as a local government or an administrative agency in an existing alarm system, and transmits an attention recommendation, an evacuation recommendation, or the like to residents. The transmission device 104 is an existing broadcasting facility such as a disaster prevention radio, an outdoor loudspeaker station, an emergency contact mail transmission device, or the like.

For example, the notification unit 4 of the flood sensor 1 notifies that the flood sensor 1 is flooded by transmitting an identifier of the flood sensor 1 to the notification server 102. The notification server 102 is connected to the database server 103 and refers to the installation position and height of the flood sensor 1 for each of the flood sensors 1 as notification sources. The notification server 102 determines the importance of the alarm according to the position and height of the flood sensor 1 that has notified of the flooding.

In addition, the notification server 102 determines the importance of the alarm according to the number of flood sensors 1 that notify of the occurrence of flooding. Since it is expected that a disaster such as flooding has occurred in a wide range as the number of flood sensors 1 that notify of the occurrence of flooding is larger, the importance of the alarm is higher, and as the number of flood sensors 1 is smaller, the importance of the alarm is lower.

The notification server 102 can further determine the importance of the alarm according to a precipitation amount at the position where the flood sensor 1 is installed. As the precipitation amount is increased, the importance of the alarm is higher, and as the precipitation amount is decreased, the importance of the alarm is lower.

The processing of the notification server 102 will be described with reference to FIG. 3. In the processing illustrated in FIG. 3, when a signal is received from a certain flood sensor 1, a warning level of an alarm is specified according to a signal from another flood sensor 1, a rainfall amount, and the like, and is notified to an existing alarm system. The processing illustrated in FIG. 3 is an example, and the present invention is not limited thereto.

First, when receiving a signal indicating that flooding has occurred from a certain flood sensor 1 in step S1, the notification server 102 waits for reception of a signal from another flood sensor 1 for a predetermined time in step S2. When a signal is not received from another flood sensor 1, the process proceeds to step S3, and when a signal is received from another flood sensor 1, the process proceeds to step S7.

In step S3, the notification server 102 specifies the location where the flood sensor 1 from which the signal is received in step S1 is installed based on the database server 103 or the like, and acquires the precipitation amount in the most recent predetermined time of the district including the location from the weather server (not illustrated) or the like. When it is determined in step S4 that the precipitation amount acquired in step S3 is not equal to or more than a threshold value, the notification server 102 recognizes the occurrence of an early attention alarm in step S5. When it is determined in step S4 that the precipitation amount acquired in step S3 is equal to or more than a threshold value, the notification server 102 recognizes the occurrence of a warning alarm in step S6.

In step S7, when the number of signals received during standby in step S1 is equal to or greater than a threshold value, the notification server 102 considers that flooding has occurred in a wide range. In step S7, the notification server 102 estimates the flood height and determines whether or not the estimated flood height is equal to or greater than a threshold value. The notification server 102 estimates the flood height in the area from the height at which each flood sensor 1 notified of flooding is installed during standby in step S2 and the height at which each flood sensor 1 not notified of flooding is installed. When it is determined in step S7 that the flood height is equal to or greater than the threshold value, the notification server 102 recognizes the occurrence of an important warning alarm in step S9. When it is determined in step S7 that the flood height is not equal to or greater than the threshold value, the notification server 102 proceeds to step S8.

When it is determined in step S8 that the number of signals received during standby in step S1 is equal to or greater than the threshold value, the notification server 102 recognizes the occurrence of the important warning alarm in step S9. On the other hand, when it is determined in step S8 that the number of signals received during standby in step S1 is not equal to or greater than the threshold value, the notification server 102 recognizes the occurrence of a warning-required alarm in step S10 since the occurrence range of flooding is considered to be limited.

When the occurrence of the alarm is recognized in step S5, S6, S9, or S10, the recognized alarm is notified to the existing alarm system. The existing alarm system notifies residents and the like via the transmission device 104 according to a predetermined rule.

The response to be taken by the existing alarm system to the various warning alarms is appropriately set according to the operation policy of the observer. As an example, when an early attention alarm occurs, an attention recommendation is notified to a management screen of the observer. When a warning alarm occurs, a plurality of observers are notified of attention recommendations. When an important warning alarm occurs, an evacuation recommendation is notified to the residents via the transmission device 104. When a warning-required alarm is generated, an attention recommendation is notified to the residents via the transmission device 104.

According to such a notification system 100, it is possible to specify a range where a disaster has occurred, a disaster scale, and the like according to signals from the plurality of flood sensors 1 and notify an existing alarm system of the disaster. Since the flood sensor 1 according to the embodiment of the present invention is supplied with power and notified of only when flooding occurs, maintenance is easy, and thus a large number of flood sensors 1 can be installed. In addition, since the flood sensor 1 is formed of a material that is naturally decomposed, a burden on the natural world does not occur even if the flood sensor 1 is not collected.

(Configuration of Primary Battery and Electrode Reaction)

Here, each configuration of the primary battery 3 will be described.

The negative electrode 31 is formed of a negative electrode active substance. The negative electrode 31 is formed of one or more metals selected from magnesium, zinc, aluminum, and iron, or an alloy containing, as a main component, one or more metals selected from magnesium, zinc, aluminum, and iron. The negative electrode 31 may be formed by a general method such as forming a metal or alloy plate or foil into a predetermined shape.

The positive electrode 33 is formed of a conductive material used for a positive electrode of a general metal-air battery such as a carbon material. The positive electrode 33 can be produced by a known process such as molding carbon powder with a binder. In the primary battery, it is important to generate a large amount of reaction sites in the positive electrode 33, and thus the positive electrode 33 desirably has a high specific surface area. In a case where the positive electrode 33 is produced by molding carbon powder with a binder and pelletizing the carbon powder, when the specific surface area is increased, the binding strength between the carbon particles becomes lower, and the structure deteriorates. Therefore, it is difficult for the positive electrode 33 to perform stable discharge, and the discharge capacity decreases. On the other hand, for example, when the positive electrode 33 has a three-dimensional network structure, the positive electrode 33 does not need to use a binder, and the discharge capacity can be increased. Moreover, the positive electrode 33 may carry a catalyst. The catalyst is not particularly limited, but is preferably composed of at least one metal of Fe, Mn, Zn, Cu, and Mo, or a metal oxide consisting of at least one metal of Ca, Fe, Mn, Zn, Cu, and Mo. Among them, as the metal of the catalyst, one metal of Fe, Mn, and Zn, an oxide consisting of one of these metals, or a composite oxide consisting of two or more of these metals is preferable.

The electrolyte 38 is dissolved in water to form an electrolyte solution. The electrolyte 38 is not particularly limited as long as it is a substance capable of allowing metal ions and hydroxide ions to move between the negative electrode 31 and claim 33. The electrolyte 38 is preferably composed of, for example, magnesium acetate, sodium chloride, potassium chloride, or the like. The electrolyte solution is preferably neutral in consideration of environmental influence.

A known material can be used for the negative electrode current collector 32. When a metal is used for the negative electrode 31, the primary battery 3 may be provided with no negative electrode current collector and the terminal may be taken out directly from the negative electrode 31 to the outside. A known material can be used for the positive electrode current collector 34. For the positive electrode current collector 34, for example, a plate formed of any one or more of carbon sheet, carbon cloth, Fe, Cu, and Al may be used.

Here, electrode reactions at the negative electrode 31 and the positive electrode 33 in a primary battery using magnesium metal for the negative electrode 31 will be described. Oxygen in the air and an electrolyte come into contact with each other on the surface of the positive electrode 33 having conductivity, so that the positive electrode reaction represented by Formula (1) proceeds. On the other hand, on the surface of the negative electrode 31 in contact with the electrolyte supplied by the separator 35, the negative electrode reaction represented by Formula (2) proceeds. Magnesium forming the negative electrode 31 emits electrons and is dissolved as magnesium ions in the electrolyte.

By the positive electrode reaction and the negative electrode reaction, the primary battery 3 can perform discharge. The overall reaction is a reaction in which magnesium hydroxide is generated (precipitated) as represented by Formula (3). The theoretical electromotive force is about 2.7 V.

$$\begin{matrix}[ Math . 1 ] & \\ 1 / 2 {O}_{2} + {H}_{2} O + 2 {e}^{-} \to 2 {OH}^{-} & Formula ( 1 )\end{matrix}$$

$$Mg \to {Mg}^{2 +} + 2 {e}^{-} \qquad Formula ( 2 )$$

$$Mg + 1 / 2 {O}_{2} + {H}_{2} O + 2 {e}^{-} \to {Mg ( OH )}_{2} \qquad Formula ( 3 )$$

(Method for Generating Primary Battery)

A method for generating the primary battery 3 will be described. In the embodiment of the present invention, a carbon nanofiber is used for the positive electrode 33 to produce the primary battery 3.

First, a method for producing the positive electrode 33 will be described. A commercially available carbon nanofiber sol [dispersion medium: water (H₂O), 0.4 weight %, manufactured by Sigma-Aldrich Co. LLC.] was placed in a test tube, and the test tube was immersed in liquid nitrogen for 30 minutes to completely freeze the carbon nanofiber sol. After completely freezing the carbon nanofiber sol, the frozen carbon nanofiber sol was taken out into an eggplant flask and dried in a vacuum of 10 Pa or less by a freeze dryer (manufactured by TOKYO RIKAKIKAI CO., LTD.) to obtain a stretchable co-continuous body having a three-dimensional network structure including carbon nanosheets.

Next, a method for generating the negative electrode 31 will be described. The negative electrode 31 was produced by cutting a commercially available magnesium alloy plate AZ31B (thickness 300 um, manufactured by NIPPON KINZOKU co., ltd.) into a shape having a tab for current collection in a part of a square of 20 mm×20 mm using scissors.

The separator 35 to which the electrolyte 38 adhered was produced by impregnating the separator 35 with a solution obtained by dissolving sodium chloride (NaCl, manufactured by KANTO CHEMICAL CO., INC.) in pure water at a concentration of 1 mol/L and drying the solution at a condition of 70° C. The separator 35 before the adhesion of the electrolyte 38 has a square-shaped main body portion and a tape-shaped tape portion. The main body portion is a cellulose-based separator for a battery (manufactured by NIPPON KODOSHI CORPORATION), and is formed in a square shape of 20 mm×20 mm. The tape portion is the same cellulose-based separator as the main body portion, and is formed in a tape shape of 5 mm × 50 mm.

A carbon cloth was used for the positive electrode current collector 34, and the positive electrode current collector was cut into a shape having a tab for current collection on a part of a square of 20 mm×20 mm and used. The positive electrode 33 was cut into a circular size having a diameter of 17 mm with a punch and used.

Film sheet ECOLOJU (manufactured by Mitsubishi Plastics, Inc.) was used as a material of the battery housing 37. Two cut sheets obtained by cutting the sheet into a size of 30 mm×30 mm in a plan view were prepared, and one of the cut sheets was used as a housing on the positive electrode 33 side and the other was used as a housing on the negative electrode 31 side. The air hole 39 of @10 mm was provided in the housing on the positive electrode 33 side. When a material through which air can pass is used for the positive electrode 33 and the positive electrode current collector 34, the air hole 39 may not be provided.

The negative electrode 31, the negative electrode current collector 32, and the separator 35 are disposed on the housing on the negative electrode 31 side, and the positive electrode current collector 34, the positive electrode 33, and the housing on the positive electrode 33 side is sequentially covered thereon, and the peripheral edge portions of the two housings are heat-sealed at 130° C. using a sealer and sealed. The tape portion of the separator 35 is formed to be exposed.

The total weight of the primary battery 3 thus obtained was about 2 g.

(Generation of Housing)

A method for generating the housing 2 will be described. As illustrated in FIG. 1, the housing 2 includes the primary battery 3 and the notification unit 4. The housing 2 is designed so that these can be accommodated within 100 mm × 100 mm × 50 mm. A polylactic acid (PLA) filament (manufactured by Raise 3D Technologies, Inc.) was dissolved and laminated by a Fused Filament Fabrication (FFF) method using Raise 3D Pro2 (manufactured by Raise 3D Technologies, Inc.) to create the housing 2. The PLA filament is formed of polylactic acid. Polylactic acid is a material that is naturally decomposed as described above, and therefore has a small burden on the environment.

(Generation of Notification Unit 4)

A method for generating the notification unit 4 will be described. A LoRa/GPS tracker LT-100 (manufactured by GISUPPY) is improved so that power can be turned on, and GPS reception and radio wave transmission can be performed according to driving of the primary battery 3. The exterior of the LoRa/GPS tracker LT-100 is removed and stored in the housing 2. The LoRa/GPS tracker LT-100 is connected to the positive electrode current collector 34 and the negative electrode current collector 32 of the primary battery 3 in the non-power generation state.

Since the cell voltage is assumed to be about 1.5 V, power boosted to 3.7 V by the power supply circuit 41 is used.

(Evaluation of Sensor)

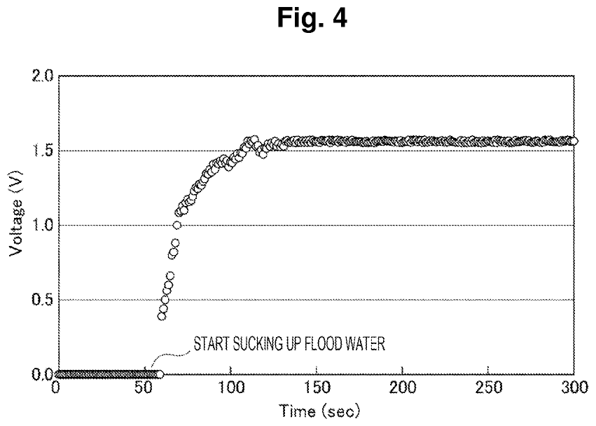

First, pure water is immersed in a tape portion of the separator 35 exposed to the outside from the housing 2. A voltage change between the negative electrode 31 and the positive electrode 33 at this time is illustrated in FIG. 4.

When the pure water was sucked up from the separator 35, the voltage rose, and a stable voltage was obtained in about 150 seconds from the start of suction. The voltage at this time was about 1.55 V. After the stable voltage was obtained, the receiver confirmed the radio wave transmission from notification unit 4. When the notification unit 4 transmitted the unique ID, the receiver also confirmed reception of these pieces of information. The receiver is a receiver capable of receiving radio waves used in the LoRa/GPS tracker LT-100, and is a LoRa gateway ES 920 LRGW (manufactured by EASEL).

When the sensor was installed in the soil after completion of the operation, decomposition of the housing was visually confirmed in about 2 months except for a commercially available circuit portion. It was shown that it was metabolized and decomposed by microorganisms in the soil.

In the flood sensor 1 according to the embodiment of the present invention, water is injected into the separator 35 in contact with the negative electrode 31 and the positive electrode 33 due to flooding of the separator 35 communicating with the outside. The electrolyte 38 adhering to the separator 35 is eluted in water and forms an electrolytic solution. The primary battery 3 generates power, and the notification unit 4 is driven by the power generation of the primary battery 3, so that flooding can be notified. The primary battery 3 of the flood sensor 1 does not need to operate at normal times, and operates in a situation where flooding occurs and the notification unit 4 needs to notify. Therefore, the primary battery 3 does not self-discharge when not active, and can be operated for a long period of time such as, for example, over 10 years.

By forming each component such as the housing 2 with a material that can be naturally decomposed, there is no need to collect the components even if the components are installed in nature, and the burden on the environment is low. The flood sensor 1 is installed in nature, and the notification server 102 installed at a position distant from the flood sensor 1 receives the notification from the flood sensor 1, so that it is possible to detect a disaster such as flooding occurring at a distant place. In addition, the plurality of flood sensors 1 are installed in nature, and the notification server 102 receives a notification of flooding from these flood sensors 1, so that it is possible to ascertain the disaster scale or the like without going to the site. In addition, by referring to weather information such as the rainfall amount at the place where the flood sensor 1 is installed, it is possible to recognize the disaster warning level and transmit an alarm to residents and the like.

(First Modification)

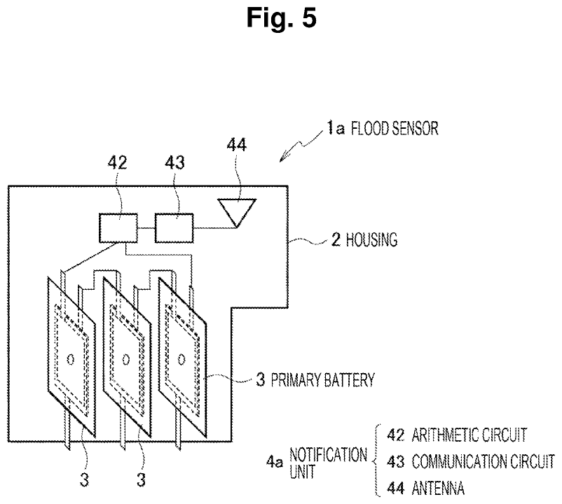

In the embodiment of the present invention, the case where the notification unit 4 of the flood sensor 1 includes the power supply circuit 41 has been described. On the other hand, as illustrated in FIG. 5, a description will be given of a case where a notification unit 4a of a flood sensor 1a according to a first modification does not include a power supply circuit but includes a plurality of primary batteries 3.

In the flood sensor 1a according to the first modification, the notification unit 4a includes an arithmetic circuit 42, a communication circuit 43, and an antenna 44. The plurality of primary batteries 3 are connected in series, and power is supplied at a sufficient voltage. In such a flood sensor 1a, it is not necessary to boost the voltage, and the power supply circuit 41 may be omitted. In this case, the power supplied from the negative electrode current collector 32 and the positive electrode current collector 34 is directly provided to each circuit of the notification unit 4. In the example illustrated in FIG. 5, the primary battery 3 is connected to the arithmetic circuit 42 of the notification unit 4a. The communication circuit 43 and the antenna 44 of the notification unit 4a are driven using power supplied from the three primary batteries 3 via the arithmetic circuit 42.

In the example illustrated in FIG. 5, a case where the three primary batteries 3 are arranged in the horizontal direction will be described, but the present invention is not limited thereto. The plurality of primary batteries 3 may be connected in series, and are disposed by any method such as arranging in the vertical direction.

### (Second Modification)

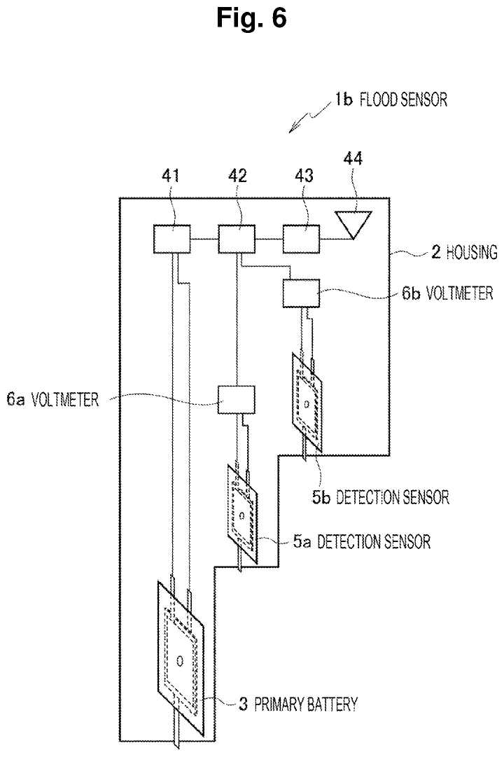

In the embodiment of the present invention, the case where the flood sensor 1 includes one primary battery 3 has been described. On the other hand, a case where a flood sensor 1b according to a second modification includes a detection sensor and a voltmeter as illustrated in FIG. 6, and the arithmetic circuit 42 estimates the flood height will be described.

The flood sensor 1b according to the second modification includes a first detection sensor 5a, a second detection sensor 5b, a first voltmeter 6a, and a second voltmeter 6b. In the second modification, a case where two detection sensors are provided will be described, but one detection sensor may be provided, or three or more detection sensors may be provided.

The first detection sensor 5a and the second detection sensor 5b are provided above the primary battery 3 and provided at different heights. In the example illustrated in FIG. 6, the second detection sensor 5b is provided above the first detection sensor 5a.

The first detection sensor 5a has the configuration similar to that of the primary battery 3. Specifically, the first detection sensor 5a includes a positive electrode, a negative electrode, and a separator that is disposed between the positive electrode and the negative electrode and to which an electrolyte adheres. A positive electrode current collector may be provided between the positive electrode and the separator. A negative electrode current collector may be provided between the negative electrode and the separator. When the separator of the first detection sensor 5a is flooded, the electrolyte adhering to the separator is dissolved in water to form an electrolyte solution, and the first detection sensor 5a starts generating power. The first voltmeter 6a measures the voltage of the power supplied by the first detection sensor 5a and inputs the voltage to the arithmetic circuit 42. Since the first detection sensor 5a is provided above the primary battery 3, the first detection sensor 5a starts generating power when flooding further progresses after the primary battery 3 starts generating power.

The second detection sensor 5b and the second voltmeter 6b operate similarly to the first detection sensor 5a. However, since the second detection sensor 5b is provided above the first detection sensor 5a, the second detection sensor 5b starts generating power when flooding further progresses after the first detection sensor 5a starts generating power.

When driven by the power supplied from the primary battery 3, the notification unit 4 notifies that flooding is occurring at a height of the primary battery 3 in the vertical direction. When power generation due to flooding of the separator of the first detection sensor 5a is detected after the power supplied from the primary battery 3 is driven, the notification unit 4 notifies that flooding is occurring at a height of the first detection sensor 5a in the vertical direction. The notification unit 4 recognizes power generation due to flooding of the separator at a point in time when the voltage value of the first voltmeter 6a becomes a threshold value indicating that the detection sensor 5a is generating power. When power generation due to flooding of the separator of the second detection sensor 5b is detected after power generation by the first detection sensor 5a is detected, the notification unit 4 notifies that flooding is occurring at a height of the second detection sensor 5b in the vertical direction.

In the second modification, the arithmetic circuit 42 can notify the notification server 102 of an index indicating the flood height in the flood sensor 1b in addition to being flooded. As illustrated in FIG. 6, the flood sensor 1b includes two detection sensors in addition to the primary battery 3. The arithmetic circuit 42 specifies the flood height in the flood sensor 1b by three indexes. The arithmetic circuit 42 sets the specified index to data, and the communication circuit 43 transmits the data to the notification server 102.

After the notification unit 4 is driven by the power supplied from the primary battery 3, the voltage value of the first voltmeter 6a may be lower than a threshold value indicating the power generation of the first detection sensor 5a, and the voltage value of the second voltmeter 6b may be lower than a threshold value indicating the power generation of the second detection sensor 5b. The arithmetic circuit 42 specifies that flooding is occurring up to the height of the primary battery 3, more specifically, the separator 35 in the vertical direction.

After the notification unit 4 is driven by the power supplied from the primary battery 3, the voltage value of the first voltmeter 6a may be higher than the threshold value indicating the power generation of the first detection sensor 5a, and the voltage value of the second voltmeter 6b may be lower than the threshold value indicating the power generation of the second detection sensor 5b.

The arithmetic circuit 42 specifies that flooding is occurring up to the height of the first detection sensor 5a, more specifically, the separator of the first detection sensor 5a in the vertical direction.

After it is determined that the first voltmeter 6a is higher than the threshold value indicating power generation by the first detection sensor 5a, the voltage value of the second voltmeter 6b may also be higher than the threshold value indicating power generation by the second detection sensor 5b. The arithmetic circuit 42 specifies that flooding is occurring up to the height of the second detection sensor 5b, more specifically, the separator of the second detection sensor 5b in the vertical direction. Note that the voltage value of the first voltmeter 6a is not limited in consideration of a case where the first detection sensor 5a already ends power generation in a state where the voltage value of the second voltmeter 6b is higher than a predetermined threshold value.

Thus, in the flood sensor 1b according to the second modification, in addition to the primary battery 3, the detection sensor having the configuration similar to that of the primary battery 3 is installed above the primary battery 3, and further, the voltage generated by the power generation of the detection sensor is monitored. The flood sensor 1b can estimate the flood height in the flood sensor 1b and notify the notification server 102 of flooding.

The flood sensor 1b according to the second modification can also be applied to the notification system 100 illustrated in FIG. 2. In this case, in step S7 of the flowchart illustrated in FIG. 3, the type of the alarm may be determined depending on whether or not the value of the flood height notified from each flood sensor 1b satisfies a predetermined condition.

For the notification server 102 and the database server 103 of the present embodiment described above, a general-purpose computer system including, for example, a central processing unit (CPU, a processor) 901, a memory 902, a storage 903 (a hard disk drive (HDD) or a solid state drive (SSD)), and a communication device 904, an input device 905, and an output device 906 is used. In the computer system, by the CPU 901 executing a predetermined program loaded on the memory 902, the functions of the notification server 102 and the database server 103 are implemented.

The notification server 102 and the database server 103 may each be implemented by one computer, or may be implemented by a plurality of computers. Furthermore, the notification server 102 and the database server 103 may each be a virtual machine mounted on a computer.

Each program of the notification server 102 and the database server 103 can be stored in a computer-readable recording medium such as an HDD, an SSD, a Universal Serial Bus (USB) memory, a compact disc (CD), or a digital versatile disc (DVD), or can be distributed via a network.

Note that the present invention is not limited to the above embodiment, and various modifications can be made within the scope of the gist of the present invention.

### REFERENCE SIGNS LIST

1 Flood sensor
2 Housing
3 Primary battery
4 Notification unit
31 Negative electrode
32 Negative electrode current collector
33 Positive electrode
34 Positive electrode current collector
35 Separator
36 Basic cell
37 Battery housing
38 Electrolyte
39 Air hole
41 Power supply circuit
42 Arithmetic circuit
43 Communication circuit
44 Antenna
100 Notification system
101 Base station
102 Notification server
103 Database server
104 Transmission device
901 CPU
902 Memory
903 Storage
904 Communication device
905 Input device
906 Output device

1. A flood sensor comprising:
a notification unit that notifies of detection of flooding; and
a primary battery,
wherein
the primary battery includes a positive electrode, a negative electrode, and a separator that is disposed between the positive electrode and the negative electrode and to which an electrolyte adheres, and
when the separator is flooded, the electrolyte is dissolved in water to form an electrolyte solution, and the primary battery starts generating power to supply power necessary for driving the notification unit.

2. The flood sensor according to claim 1, further comprising a plurality of primary batteries connected in series.

3. The flood sensor according to claim 1, further comprising a detection sensor provided above the primary battery,
wherein
the detection sensor includes a positive electrode, a negative electrode, and a separator that is disposed between the positive electrode and the negative electrode and to which an electrolyte adheres, and
the notification unit
notifies that flooding is occurring at a height of the primary battery in a vertical direction when driven by the power supplied from the primary battery, and
notifies that flooding is occurring at a height of the detection sensor in the vertical direction when power generation due to flooding of the separator of the detection sensor is detected after driving with the power supplied from the primary battery.

4. The flood sensor according to claim 1, wherein the negative electrode is formed of one or more metals selected from magnesium, zinc, aluminum, and iron, or an alloy containing, as a main component, one or more metals selected from magnesium, zinc, aluminum, and iron.

5. The flood sensor according to claim 1, wherein the separator is formed of an insulator having water absorbency.

6. A notification system comprising:
the flood sensor according to claim 1; and
a notification server that is connected to the flood sensor and refers to a position and a height of the flood sensor,
wherein
the notification unit of the flood sensor notifies of flooding of the flood sensor, and
the notification server determines an importance of an alarm according to the position and the height of the flood sensor that has notified of flooding.

7. The notification system according to claim 6, wherein the notification server determines the importance of the alarm according to the number of the flood sensors that notify of occurrence of flooding.

8. The notification system according to claim 6, wherein the notification server further determines the importance of the alarm according to a precipitation amount at a position where the flood sensor is installed.

9. The flood sensor according to claim 2, wherein the negative electrode is formed of one or more metals selected from magnesium, zinc, aluminum, and iron, or an alloy containing, as a main component, one or more metals selected from magnesium, zinc, aluminum, and iron.

10. The flood sensor according to claim 3, wherein the negative electrode is formed of one or more metals selected from magnesium, zinc, aluminum, and iron, or an alloy containing, as a main component, one or more metals selected from magnesium, zinc, aluminum, and iron.

11. The flood sensor according to claim 2, wherein the separator is formed of an insulator having water absorbency.

12. The flood sensor according to claim 3, wherein the separator is formed of an insulator having water absorbency.

13. The flood sensor according to claim 4, wherein the separator is formed of an insulator having water absorbency.

14. A notification system comprising:
the flood sensor according to claim 2; and
a notification server that is connected to the flood sensor and refers to a position and a height of the flood sensor,
wherein
the notification unit of the flood sensor notifies of flooding of the flood sensor, and
the notification server determines an importance of an alarm according to the position and the height of the flood sensor that has notified of flooding.

15. A notification system comprising:
the flood sensor according to claim 3; and
a notification server that is connected to the flood sensor and refers to a position and a height of the flood sensor,
wherein
the notification unit of the flood sensor notifies of flooding of the flood sensor, and
the notification server determines an importance of an alarm according to the position and the height of the flood sensor that has notified of flooding.

16. A notification system comprising:
the flood sensor according to claim 4; and
a notification server that is connected to the flood sensor and refers to a position and a height of the flood sensor,
wherein
the notification unit of the flood sensor notifies of flooding of the flood sensor, and
the notification server determines an importance of an alarm according to the position and the height of the flood sensor that has notified of flooding.

17. A notification system comprising:
the flood sensor according to claim 5; and
a notification server that is connected to the flood sensor and refers to a position and a height of the flood sensor,
wherein
the notification unit of the flood sensor notifies of flooding of the flood sensor, and
the notification server determines an importance of an alarm according to the position and the height of the flood sensor that has notified of flooding.

18. The notification system according to claim 7, wherein the notification server further determines the importance of the alarm according to a precipitation amount at a position where the flood sensor is installed.
